(19) United States
(12) Patent Application Publication
(10) Pub. No.: US 2006/0282824 A1
(43) Pub. Date: Dec. 14, 2006

(54) Methods and systems for monitoring enterprise file currency

(75) Inventors: Charles E. Atchison, Alpharetta, GA (US); Goutham Belliappa, Atlanta, GA (US)

Correspondence Address: MERCHANT & GOULD BELLSOUTH CORPORATION, P.O. BOX 2903, MINNEAPOLIS, MN, 55402, US

(73) Assignee: BellSouth Intellectual Property Corporation

(21) Appl. No.: 11/147,545

(22) Filed: Jun. 8, 2005

(51) Int. Cl. G06F 9/44

(52) U.S. Cl. 717/127

(57) ABSTRACT

Systems and methods are disclosed for monitoring enterprise file currency. The disclosed systems and methods may include creating a currency check and notification configuration. Furthermore, the disclosed systems and methods may include executing a currency check based on the currency check and notification configuration and reporting the results of the currency check.

### BACKGROUND OF THE INVENTION

I. Field of the Invention

The present invention generally relates to methods and systems for monitoring enterprise file currency. More particularly, the present invention relates to monitoring enterprise file currency and providing monitoring results.

II. Background Information

Monitoring enterprise file currency is a process for providing notification when out-of-date data is found. In some situations, groups within an enterprise may not have the most up-to-date data. For example, a group within an enterprise may receive data from several source systems. This data may then be processed and disseminated across the enterprise. Due to various reasons, however, the file may not arrive at the destination. Often, business units within the enterprise deal with outdated data for a while before noticing, for example, that reports have not changed in a while. Thus, the conventional strategy is to expect individuals within a business unit to notice out-of-date data. This often causes problems because the conventional strategy does not provide business units within the enterprise outdated data notification. For example, business units within the enterprise may use outdated data for a while before noticing.

In view of the foregoing, there is a need for methods and systems for monitoring enterprise file currency more optimally. Furthermore, there is a need for monitoring enterprise file currency and providing monitoring results.

### SUMMARY OF THE INVENTION

Consistent with embodiments of the present invention, systems and methods are disclosed for monitoring enterprise file currency.

In accordance with one embodiment, a method for monitoring enterprise file currency comprises creating a currency check and notification configuration, executing a currency check based on the currency check and notification configuration, and reporting the results of the currency check.

According to another embodiment, a system for monitoring enterprise file currency comprises a memory storage for maintaining a database and a processing unit coupled to the memory storage, wherein the processing unit is operative to create a currency check and notification configuration, execute a currency check based on the currency check and notification configuration, and report the results of the currency check.

In accordance with yet another embodiment, a computer-readable medium which stores a set of instructions which when executed performs a method for monitoring enterprise file currency, the method executed by the set of instructions comprising creating a currency check and notification configuration, executing a currency check based on the currency check and notification configuration, and reporting the results of the currency check.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is a block diagram of an exemplary currency check and notification system consistent with an embodiment of the present invention;

FIG. 2 is a block diagram of the exemplary currency check and notification system of FIG. 1 in more detail consistent with an embodiment of the present invention;

FIG. 3 is a flow chart of an exemplary method for monitoring enterprise file currency consistent with an embodiment of the present invention; and

FIG. 4 through FIG. 15 are screen shots illustrating various entry and reporting elements consistent with an embodiment of the present invention.

### DETAILED DESCRIPTION

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering or adding steps to the disclosed methods. Accordingly, the following detailed description does not limit the invention. Instead, the proper scope of the invention is defined by the appended claims.

Systems and methods consistent with embodiments of the present invention monitor enterprise file currency. Groups within an enterprise receive data from several source systems that is processed to disseminate vital information across the enterprise. Due to various reasons, however, the file may not arrive at its intended destination. Often, business units within the enterprise may deal with outdated data for a while before noticing, for example, that reports have not changed in a while. Consistent with an embodiment of the invention, one solution to this problem is a tool that looks for certain files in certain folders on certain servers and then notifies a business unit within the enterprise if the files did not meet a certain required currency. In this way, the business unit is aware of a currency problem before stale or incorrect reports are distributed.

Consistent with an embodiment of the invention, a data source (comprising, for example, a database) is checked or a report currency is checked on a currency field within that report. For example, a table in the data source has a date/time field that is checked to make sure the application that uses the database is working. If the application is working, the database may have records that meet a specified currency threshold. If not, a notification is sent, for example, to individuals on an e-mail distribution list.

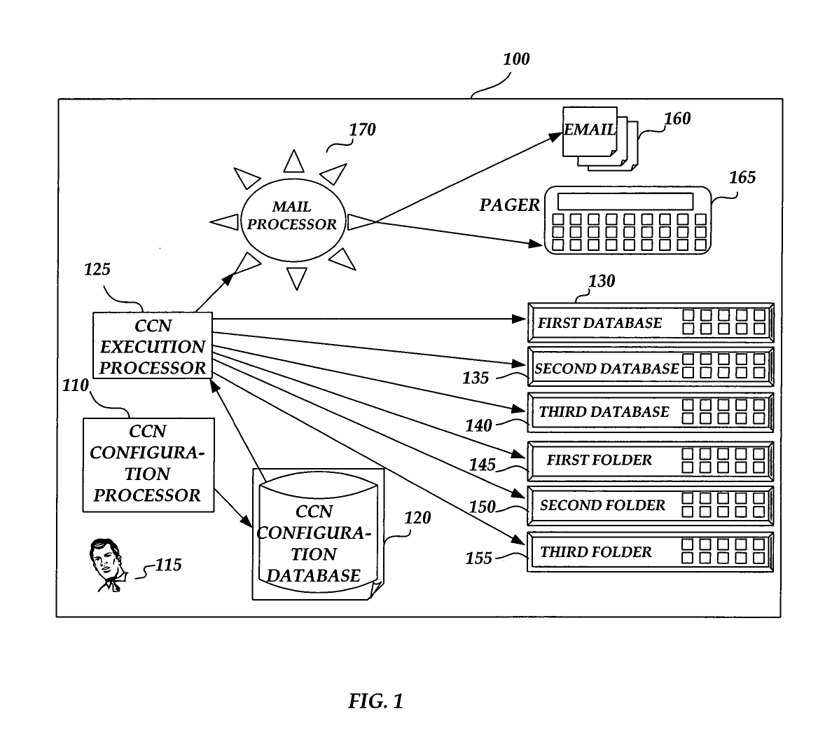

FIG. 1 is a block diagram of an exemplary currency check and notification system consistent with an embodiment of the present invention. As illustrated in the block diagram of FIG. 1, a currency check and notification (CCN) system 100 includes a CCN configuration processor 110 operated by a user 115. User 115, using processor 110, creates a CCN configuration and save it in a CCN configuration database 120. A CCN execution processor 125 receives the saved configuration from CCN configuration database 120 and perform a currency check consistent with an embodiment of the invention. For example, CCN execution processor 125 performs a currency check on at least one of a first database 130, a second database 135, a third database 140, a first folder 145, a second folder 150, and a third folder 155. Once CCN execution processor 125 performs the currency check, the results of the currency check is sent, for example, via e-mail 160 or to a pager 165 through a mail processor 170. The aforementioned are exemplary, and the results may be sent to other devices.

An embodiment consistent with the invention comprises a system for monitoring enterprise file currency. The system comprises a memory storage for maintaining a database and a processing unit coupled to the memory storage. The processing unit is operative to create a currency check and notification configuration. In addition, the processing unit is operative to execute a currency check based on the currency check and notification configuration and report the results of the currency check.

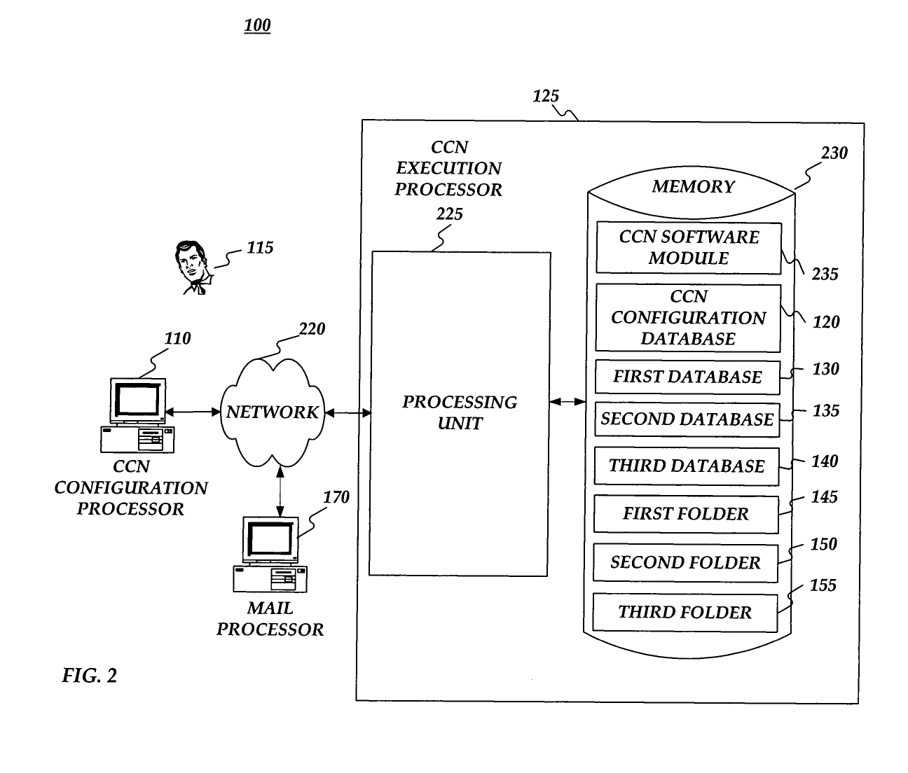

Consistent with an embodiment of the present invention, the aforementioned memory, processing unit, and other components may be implemented in a currency check and notification system, such as exemplary system 100 of FIG. 1. FIG. 2 shows system 100 in more detail. Any suitable combination of hardware, software and/or firmware may be used to implement the memory, processing unit, or other components. By way of example, the memory, processing unit, or other components may be implemented with any of CCN configuration processor 110 or CCN execution processor 125, in combination with system 100. The aforementioned system and processors are exemplary and other systems and processors may comprise the aforementioned memory, processing unit, or other components, consistent with embodiments of the present invention.

By way of a non-limiting example, FIG. 2 illustrates system 100 in which the features and principles of the present invention are implemented. As illustrated in the block diagram of FIG. 2, system 100 includes CCN configuration processor 110, CCN execution processor 125, user 115, and a network 220. User 115 may be an individual, for example, desiring to create a currency check and notification configuration using CCN configuration processor 110 or CCN execution processor 125. User 115 may also be an organization, enterprise, or any other entity having such desires.

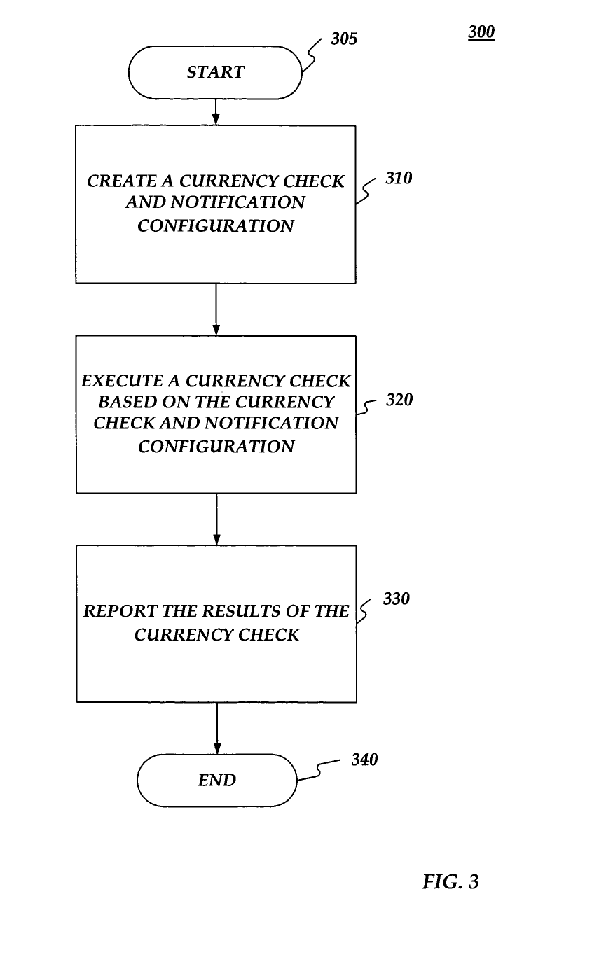

CCN execution processor 125 includes a processing unit 225 and a memory 230. Memory 230 includes: i) a CCN software module 235; ii) CCN configuration database 120; iii) first database 130; iv) second database 135; v) third database 140; vi) first folder 145; vii) second folder 150; and viii) third folder 155. Software module 235 residing in memory 230 is executed on processing unit 225 and may access any one or more of databases 120, 130,135, and 140 and any one or more of folders 145, 150, and 155. While executing on processing unit 225, software module 235 may perform embodiments of the invention including, for example, one or more of the stages of method 300 described below with respect to FIG. 3. Furthermore, any combination of software module 235, databases 120,130, 135, and 140, and folders 145, 150, and 155 may be executed on or reside in any one or more of the processors shown in FIG. 1 and FIG. 2.

CCN configuration processor 110, CCN execution processor 125, or mail processor 170 (“the processors”) included in system 100 may be implemented using a personal computer, network computer, mainframe, or other similar microcomputer-based workstation. The processors may though comprise any type of computer operating environment, such as hand-held devices, multiprocessor systems, microprocessor-based or programmable sender electronic devices, minicomputers, mainframe computers, and the like. The processors may also be practiced in distributed computing environments where tasks are performed by remote processing devices. Furthermore, any of the processors may comprise a mobile terminal, such as a smart phone, a cellular telephone, a cellular telephone utilizing wireless application protocol (WAP), personal digital assistant (PDA), intelligent pager, portable computer, a hand held computer, a conventional telephone, or a facsimile machine. The aforementioned systems and devices are exemplary and the processor may comprise other systems or devices.

Network 220 may comprise, for example, a local area network (LAN) or a wide area network (WAN). Such networking environments are commonplace in offices, enterprise-wide computer networks, intranets, and the Internet, and are known by those skilled in the art. When a LAN is used as network 220, a network interface located at any of the processors may be used to interconnect any of the processors. When network 220 is implemented in a WAN networking environment, such as the Internet, the processors may typically include an internal or external modem (not shown) or other means for establishing communications over the WAN. Further, in utilizing network 220, data sent over network 220 may be encrypted to insure data security by using known encryption/decryption techniques.

In addition to utilizing a wire line communications system as network 220, a wireless communications system, or a combination of wire line and wireless may be utilized as network 220 in order to, for example, exchange web pages via the Internet, exchange e-mails via the Internet, or for utilizing other communications channels. Wireless can be defined as radio transmission via the airwaves. However, it may be appreciated that various other communication techniques can be used to provide wireless transmission, including infrared line of sight, cellular, microwave, satellite, packet radio, and spread spectrum radio. The processors in the wireless environment can be any mobile terminal, such as the mobile terminals described above. Wireless data may include, but is not limited to, paging, text messaging, e-mail, Internet access and other specialized data applications specifically excluding or including voice transmission. For example, the processors may communicate across a wireless interface such as, for example, a cellular interface (e.g., general packet radio system (GPRS), enhanced data rates for global evolution (EDGE), global system for mobile communications (GSM)), a wireless local area network interface (e.g., WLAN, IEEE 802.11), a bluetooth interface, another RF communication interface, and/or an optical interface.

System 100 may also transmit data by methods and processes other than, or in combination with, network 220. These methods and processes may include, but are not limited to, transferring data via, diskette, flash memory sticks, CD ROM, facsimile, conventional mail, an interactive voice response system (IVR), or via voice over a publicly switched telephone network.

FIG. 3 is a flow chart setting forth the general stages involved in an exemplary method 300 consistent with the invention for monitoring enterprise file currency using system 100 of FIG. 1. Exemplary ways to implement the stages of exemplary method 300 will be described in greater detail below. Exemplary method 300 begins at starting block 305 and proceeds to stage 310 where CCN configuration processor 110 creates a currency check and notification configuration. For example, CCN configuration processor 110 may allow user 115 to create the configuration. CCN configuration processor 110 may allow user 115 to set up the following exemplary parameters: i) mail server settings (through which notifications may be routed); ii) a distribution list (e.g. list of people who may be notified if the currency check does not meet requirements); and iii) a list of folders and files that may be checked.

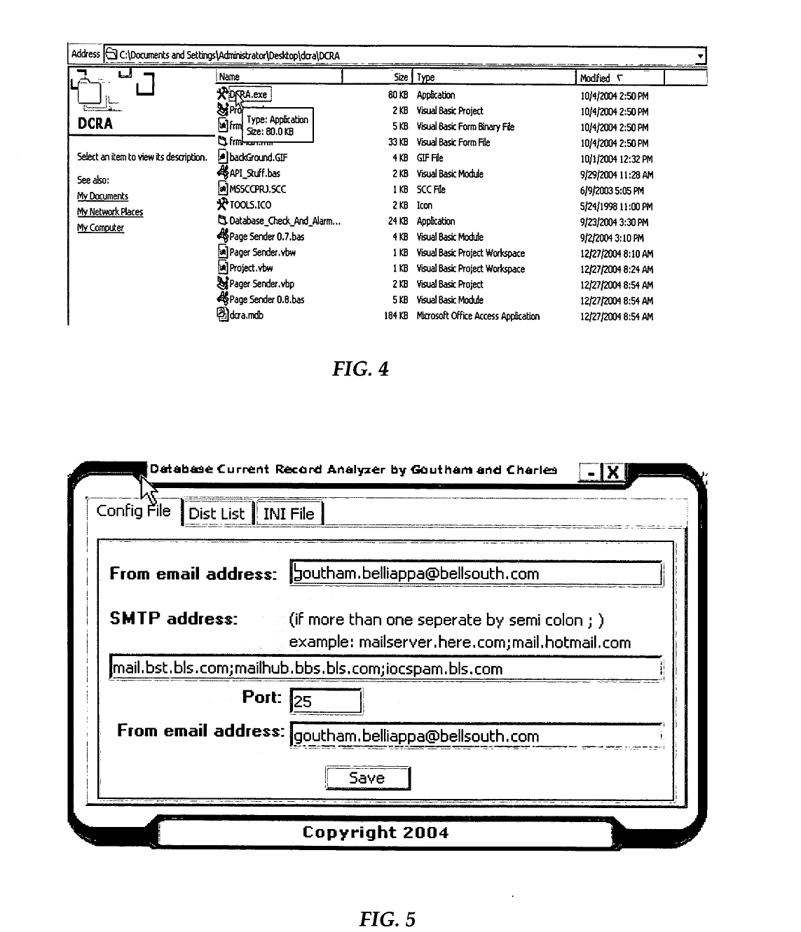

As shown in FIG. 4, to create the configuration, user 115 goes to a folder in memory 230 where CCN software module 235 (e.g. DCRA.EXE) is located. To execute software module 235, user 115 double clicks on DCRA.EXE as shown in FIG. 4. Once executed, software module 235 opens on a mail server configuration tab as shown in FIG. 5. User 115 configures “from e-mail address”, a “SMTP address” (mail server) to use, and a “port” on the mail server to use. This allows software module 235 to communicate with mail processor 170 to send out currency check results.

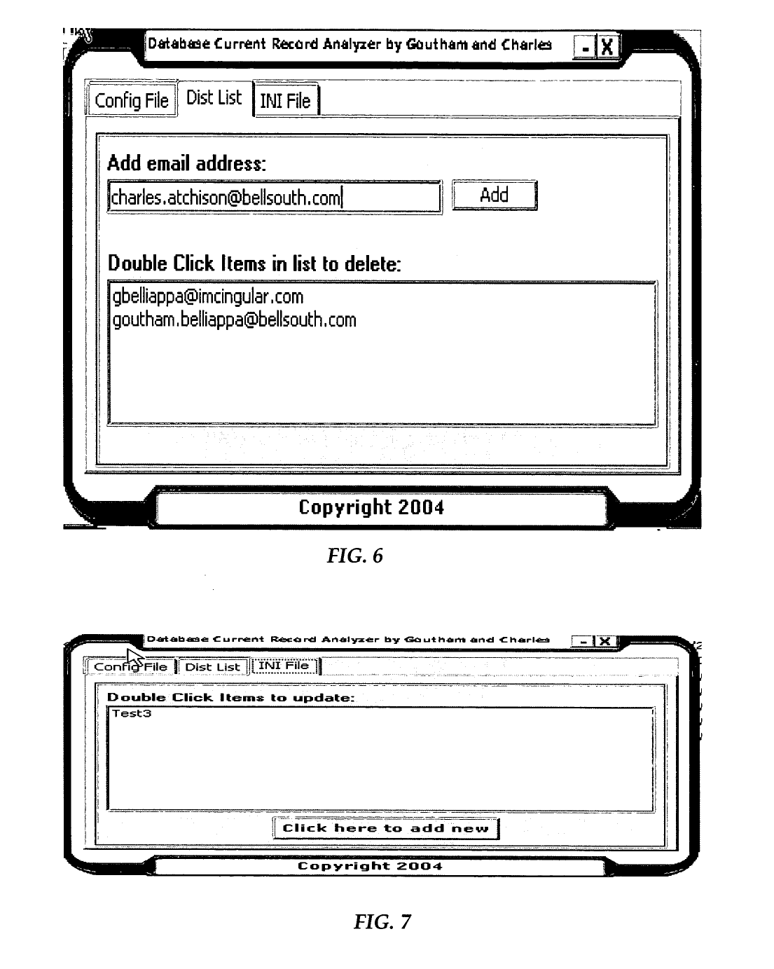

Once user 115 sets up the mail server settings as shown in FIG. 5, user 115 sets-up a distribution list of people who are notified in case a lack of currency (currentness) of the file is detected. The distribution list is illustrated in FIG. 6. For example, user 115 sets up any number of e-mail address corresponding to people who are to be notified in case of a lack of currency.

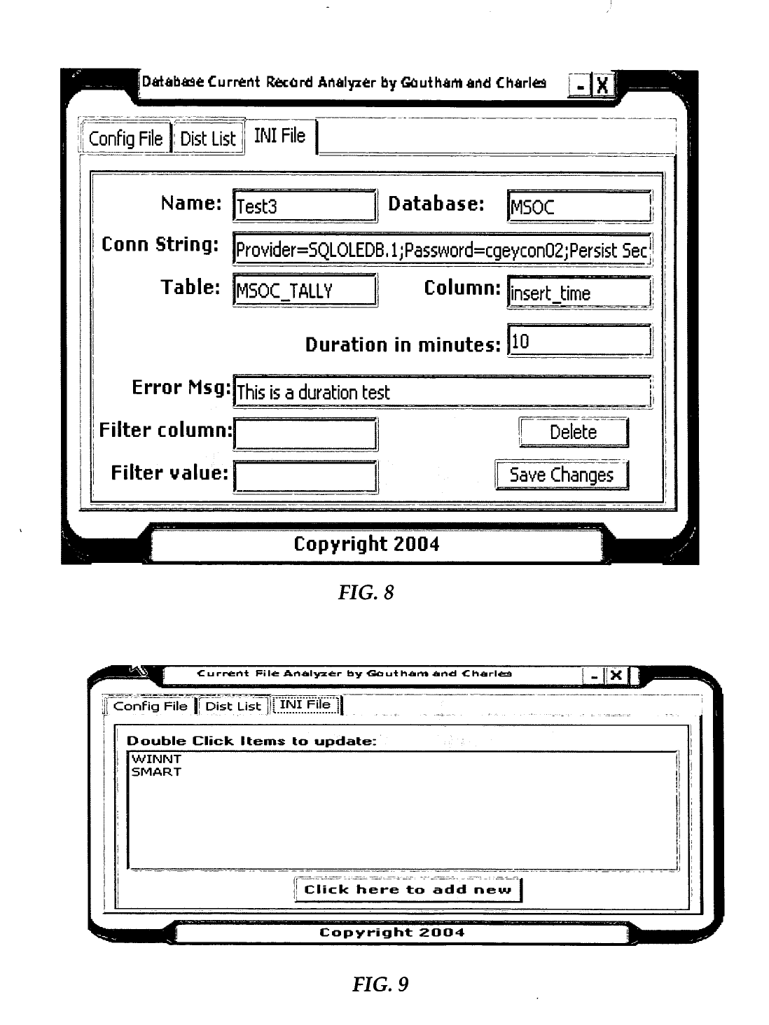

Once the distribution list is set up, user 115, for example, sets up a list of database tables to check for currency. To do this, user 115 clicks on the INI FILE tab as shown in FIG. 7. At the INI FILE tab, an overview of the databases or tables already set up is shown in FIG. 7. To add another table or database to the list, user 115 clicks on the add new button. This brings user 115 to a table configuration page as shown in FIG. 8.

As shown in FIG. 8, user 115 fills in all the fields and click to save another table or database to the list. An explanation of the fields may comprise: i) Name-friendly name for this entry; ii) Database-friendly name for the database; iii) Conn String-connection string to connect to the database; iv) Table-name of the table to look; v) Column-name of the column containing the date field that may be checked; vi) Duration-required currency of the latest date in the column; vii) Error Message-message to be sent when the currency field failed; viii) Filter Column-if there is a need to filter the data in the table the column on which the filter may be applied; and ix) Filter Value-value that may be in the filter column. To update an entry that has already been created, user 115 may double click on the folder entry and edit any fields.

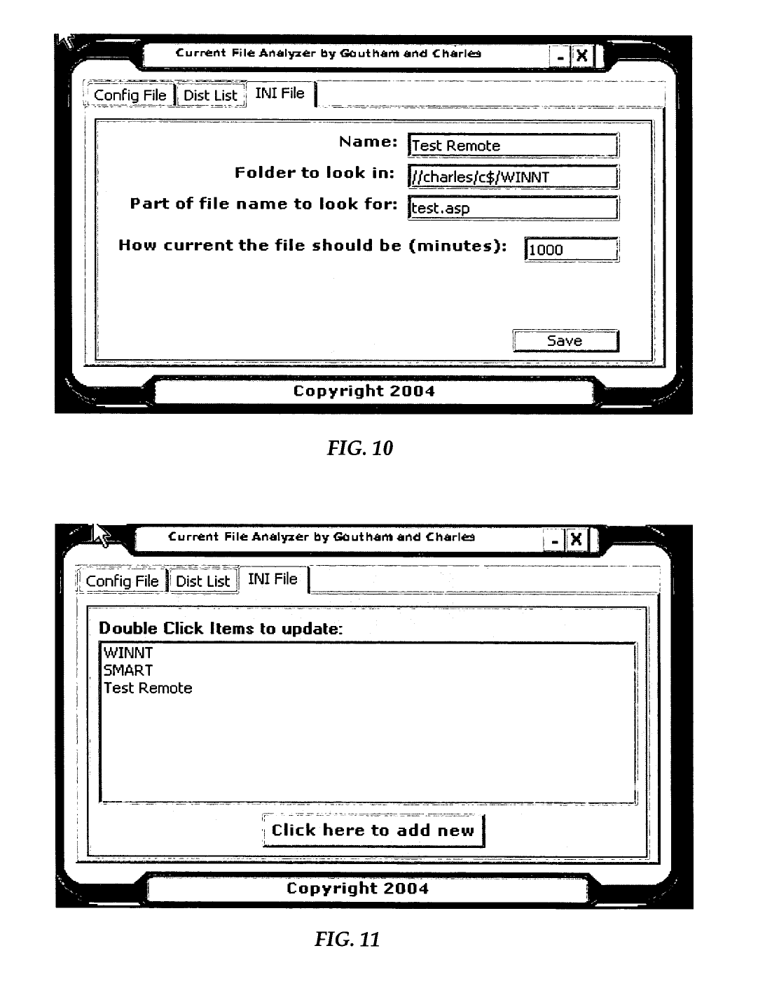

Alternately, once the distribution list is set up, user 115 may, for example, set up a list of folders and files rather than database tables to check for currency. Accordingly, once the distribution list is set up, user 115 may set up the list of folders and files to check. To do this, user 115 may click on the INI FILE tab as shown in FIG. 9. FIG. 9 shows folders that are already set up. To add another folder to the list, user 115 may click on the “add new” button. This may display a folder configuration page as shown in FIG. 10. User 115 may fill in all the fields and click save. As shown in FIG. 11, the new folder may be added to the list of folders that may be checked. To update an entry that has already been created, user 115 may double click on the folder entry in FIG. 11 and edit any desired fields.

From stage 310, where CCN configuration processor 110 creates the currency check and notification configuration, exemplary method 300 advances to stage 320 where CCN execution processor 125 executes a currency check based on the currency check and notification configuration. For example, once the configuration is complete, user 115 schedules periodically the monitoring of enterprise file currency, a function of software module 235. For example, this operation may be transparent to user 115 once the configuration is complete.

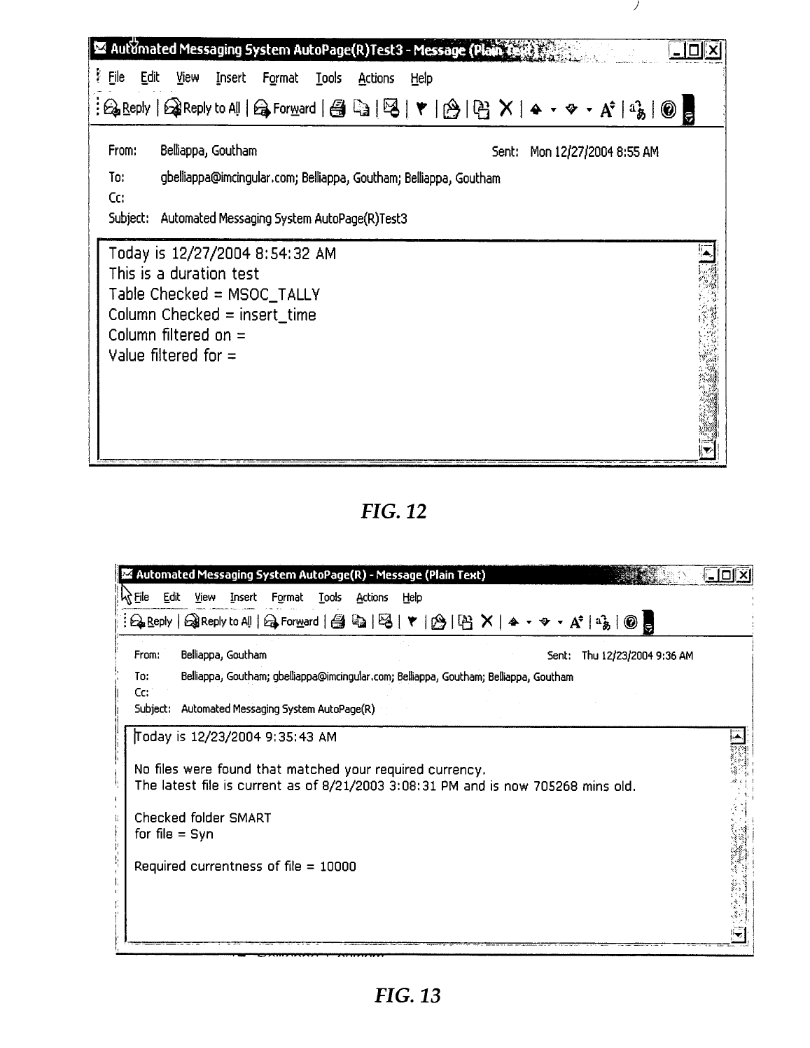

Once CCN execution processor 125 executes the currency check based on the currency check and notification configuration in stage 320, exemplary method 300 continues to stage 330 where CCN execution processor 125 reports the results of the currency check. For example, processor 125 sends out a message if no records meet the criteria specified in the configuration. FIG. 12 shows a sample results message for the aforementioned database tables check for currency.

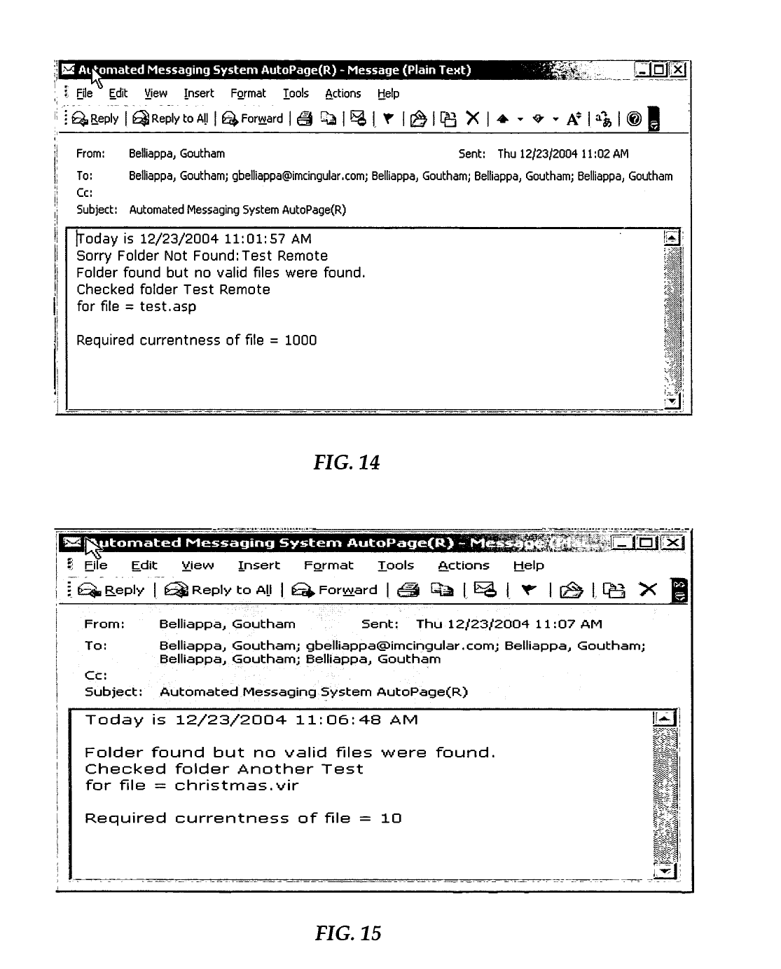

Regarding folders and files check for currency, processor 125 sends out pages under three exemplary circumstances: i) the folder was found, and the file was found but none matched the currency criteria (FIG. 13.); ii) the folder was found, but no file was found that matched the file parameters set up (FIG. 14); and iii) the folder itself is invalid (FIG. 15.) After CCN execution processor 125 reports the results of the currency check in stage 330, exemplary method 300 may proceed to stage 340 where exemplary method 300 may then end.

The present invention may be embodied as systems, methods, and/or computer program products. Accordingly, the present invention may be embodied in hardware and/or in software (including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Furthermore, the invention may be practiced in an electrical circuit comprising discrete electronic elements, packaged or integrated electronic chips containing logic gates, a circuit utilizing a microprocessor, or on a single chip containing electronic elements or microprocessors. The invention may also be practiced using other technologies capable of performing logical operations such as, for example, AND, OR, and NOT, including but not limited to mechanical, optical, fluidic, and quantum technologies. In addition, the invention may be practiced within a general purpose computer or in any other circuits or systems.

The present invention is described above with reference to block diagrams and/or operational illustrations of methods, systems, and computer program products according to embodiments of the invention. It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

While certain features and embodiments of the invention have been described, other embodiments of the invention will be apparent to those skilled in the art from consideration of the specification and practice of the embodiments of the invention disclosed herein. Furthermore, although embodiments of the present invention have been described as being associated with data stored in memory and other storage mediums, one skilled in the art will appreciate that these aspects can also be stored on or read from other types of computer-readable media, such as secondary storage devices, like hard disks, floppy disks, or a CD-ROM, a carrier wave from the Internet, or other forms of RAM or ROM. Further, the steps of the disclosed methods may be modified in any manner, including by reordering steps and/or inserting or deleting steps, without departing from the principles of the invention.

It is intended, therefore, that the specification and examples be considered as exemplary only, with a true scope and spirit of the invention being indicated by the following claims and their full scope of equivalents.

What is claimed is:

1. A method for monitoring enterprise file currency, the method comprising:
creating a currency check and notification configuration;
executing a currency check based on the currency check and notification configuration; and
reporting the results of the currency check.

2. The method of claim 1, wherein creating the currency check and notification configuration further comprises creating a configuration database that includes mail server settings through which notifications are routed.

3. The method of claim 1, wherein creating the currency check and notification configuration further comprises creating a configuration database that includes a distribution list indicating where notifications are sent.

4. The method of claim 1, wherein creating the currency check and notification configuration further comprises creating a configuration database that includes a list of folders, files, or databases to check.

5. The method of claim 1, wherein creating the currency check and notification configuration further comprises creating a configuration database that includes a list of folders, files, or databases to check, the list including at least one of: i) an entry name; ii) a folder, file, or database name; iii) a string name to connect to a folder, file, or database; iv) a table name; v) a column name of a column containing a date field that is to be checked; vi) a duration value comprising the required currency of a latest date in the column; vii) an error message to be sent when the currency fails; viii) a filter column comprising a column name on which a filter is to be applied; and ix) a filter value comprise a value to check for in the filter column.

6. The method of claim 1, wherein executing the currency check based on the currency check and notification configuration further comprises executing the currency check periodically.

7. The method of claim 1, wherein reporting the results of the currency check further comprises reporting at least one of: i) a folder was found, and a file was found but none matched a currency criteria; ii) the folder was found, but no file was found that matched a file parameters set up; and iii) the folder itself is invalid.

8. A system for monitoring enterprise file currency, the system comprising:
a memory storage for maintaining a database; and
a processing unit coupled to the memory storage, wherein the processing unit is operative to:
create a currency check and notification configuration;
execute a currency check based on the currency check and notification configuration; and
report the results of the currency check.

9. The system of claim 8, wherein the processing unit being operative to create the currency check and notification configuration further comprises the processing unit being operative to create a configuration database that includes mail server settings through which notifications are routed.

10. The system of claim 8, wherein the processing unit being operative to create the currency check and notification configuration further comprises the processing unit being operative to create a configuration database that includes a distribution list indicating where notifications are sent.

11. The system of claim 8, wherein the processing unit being operative to create the currency check and notification configuration further comprises the processing unit being operative to create a configuration database that includes a list of folders, files, or databases to check.

12. The system of claim 8, wherein the processing unit being operative to create the currency check and notification configuration further comprises the processing unit being operative to create a configuration database that includes a list of folders, files, or databases to check, the list including at least one of: i) an entry name; ii) a folder, file, or database name; iii) a string name to connect to a folder, file, or database; iv) a table name; v) a column name of a column containing a date field that is to be checked; vi) a duration value comprising the required currency of a latest date in the column; vii) an error message to be sent when the currency fails; viii) a filter column comprising a column name on which a filter is to be applied; and ix) a filter value comprise a value to check for in the filter column.

13. The system of claim 8, wherein the processing unit being operative to report the results of the currency check further comprises the processing unit being operative to report at least one of: i) a folder was found, and a file was found but none matched a currency criteria; ii) the folder was found, but no file was found that matched a file parameters set up; and iii) the folder itself is invalid.

14. A computer-readable medium which stores a set of instructions which when executed performs a method for monitoring enterprise file currency, the method executed by the set of instructions comprising:
creating a currency check and notification configuration;
executing a currency check based on the currency check and notification configuration; and
reporting the results of the currency check.

15. The computer-readable medium of claim 14, wherein creating the currency check and notification configuration further comprises creating a configuration database that includes mail server settings through which notifications are routed.

16. The computer-readable medium of claim 14, wherein creating the currency check and notification configuration further comprises creating a configuration database that includes a distribution list indicating where notifications are sent.

17. The computer-readable medium of claim 14, wherein creating the currency check and notification configuration further comprises creating a configuration database that includes a list of folders, files, or databases to check.

18. The computer-readable medium of claim 14, wherein creating the currency check and notification configuration further comprises creating a configuration database that includes a list of folders, files, or databases to check, the list including at least one of: i) an entry name; ii) a folder, file, or database name; iii) a string name to connect to a folder, file, or database; iv) a table name; v) a column name of a column containing a date field that is to be checked; vi) a duration value comprising the required currency of a latest date in the column; vii) an error message to be sent when the currency fails; viii) a filter column comprising a column name on which a filter is to be applied; and ix) a filter value comprise a value to check for in the filter column.

19. The computer-readable medium of claim 14, wherein executing the currency check based on the currency check and notification configuration further comprises executing the currency check periodically.

20. The computer-readable medium of claim 14, wherein reporting the results of the currency check further comprises reporting at least one of: i) a folder was found, and a file was found but none matched a currency criteria; ii) the folder was found, but no file was found that matched a file parameters set up; and iii) the folder itself is invalid.
